(19) United States
(12) Patent Application Publication
(10) Pub. No.: US 2024/0346723 A1
(43) Pub. Date: Oct. 17, 2024

(54) SYSTEM AND METHOD OF GENERATING SAMPLE LABELS

(71) Applicant: HCL Technologies Limited, New Delhi (IN)

(72) Inventors: HARIPRASATH J, Chennai (IN); ANURAG DASH, Chennai (IN); RAKESH KUMAR SIDHARTHAN, Chennai (IN)

(21) Appl. No.: 18/626,428

(22) Filed: Apr. 4, 2024

(30) Foreign Application Priority Data
Apr. 13, 2023 (IN) 202311027543

(51) Int. Cl. G06T 11/60; G06F 3/04817; G06N 20/00; G06T 3/60

(52) U.S. Cl. CPC G06T 11/60; G06N 20/00; G06T 3/60; G06F 3/04817; G06T 2200/24

(57) ABSTRACT

The method and system for generating sample labels is disclosed. The method includes receiving, from a user, a selection of: one or more icons from a plurality of icons; and one or more backgrounds from a plurality of backgrounds. The method further includes creating a first plurality of variation-icons corresponding to each of the one or more icons, by applying one or more pre-augmentation operations to each of the one or more icons and selecting a set of variation-icons from a second plurality of variation-icons corresponding to the one or more icons, based on dimensions of each variation-icon of the set of variation-icons and predefined dimensions of a sample label template. The method further includes applying a background to the sample label template and positioning the set of variation-icons in the sample label template over the background, to generate a sample label.

### TECHNICAL FIELD

This disclosure relates generally to dataset creation, and more particularly to method and system for generating a large number of sample labels to create the dataset.

### BACKGROUND

Labelling is an important operation in medical, pharmaceuticals, and appliances manufacturing industries. Labelling conveys information and description on the products which enables users to handle the products properly. The labels contain standard symbols, icons, and texts describing various features of the product including manufacturer name, place of use, type of handling, etc. Hence, there is a need for computer vision system to identify these labels when automation systems are used to handle these products. Further, regulatory changes and launch of enhanced or new products demand creation of new labels or modification of existing labels. This also demands computer vision to identify the existing labels, automatically determine the changes required, proofread the new labels, and ensure compliance. For example, in medical labelling applications, the symbols need to be located on the medical label automatically.

Computer vision techniques may use a machine learning (ML) models and neural network models to detect the objects/icons on the labels. The ML models require custom training using a training dataset of sample labels. The training dataset may be a combination of multiple different labels with the known positions of icons marked (annotated) on them. A large and diversified dataset enhances the quality of training of the ML models, and in turn improves the accuracy of the computer vision system. However, preparing the dataset involves tedious task of acquiring a large number of images (sample labels) and annotating them. As such, intense manual effort is required for creating dataset of a collection of images and annotating individual icons/symbols. Further, there are multiple challenges in availability of diversified combination of image set which means less fidelity image set. Moreover, preparing large datasets requires is a time-consuming process which hinders faster deployment of DL models. Further, existing techniques tend to use some ML models or conventional image processing techniques to automatically annotate the image set; however, these existing techniques suffer from drawback being computationally heavy and requiring a dataset for training the ML models.

### SUMMARY

In an embodiment, a method of generating sample labels is disclosed. The method may include receiving, from a user, a selection of: one or more icons from a plurality of icons and one or more backgrounds from a plurality of backgrounds. The method may further include creating a first plurality of variation-icons corresponding to each of the one or more icons, by applying one or more pre-augmentation operations to each of the one or more icons. The method may further include selecting a set of variation-icons from a second plurality of variation-icons corresponding to the one or more icons, based on dimensions of each variation-icon of the set of variation-icons and predefined dimensions of a sample label template. The method may further include applying a background of the one or more backgrounds to the sample label template and positioning the set of variation-icons in the sample label template over the background of the one or more backgrounds, to generate a sample label.

In another embodiment, a system for generating sample labels is disclosed. The system includes a processor and a memory. The memory stores a plurality of processor-executable instructions, which upon execution, cause the processor to receive, from a user, a selection of: one or more icons from a plurality of icons and one or more backgrounds from a plurality of backgrounds. The plurality of processor-executable instructions, upon execution, may further cause the processor to create a first plurality of variation-icons corresponding to each of the one or more icons, by applying one or more pre-augmentation operations to each of the one or more icons. The plurality of processor-executable instructions, upon execution, may further cause the processor to select a set of variation-icons from a second plurality of variation-icons corresponding to the one or more icons, based on dimensions of each variation-icon of the set of variation-icons and predefined dimensions of a sample label template. The plurality of processor-executable instructions, upon execution, may further cause the processor to apply a background of the one or more backgrounds to the sample label template and position the set of variation-icons in the sample label template over the background of the one or more backgrounds, to generate a sample label.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating sample labels, in accordance with an embodiment of the present disclosure.

FIG. 2 is a block diagram of a sample label generating device showing one or more modules, in accordance with some embodiments.

FIG. 3 is a snapshot of an exemplary user interface for receiving selection of one or more icons and one or more backgrounds, in accordance with some embodiments.

FIG. 4 illustrates a sample label including one or more icons and symbols, in accordance with some embodiments.

FIGS. 5A-5B depict a flowchart of a method of generating sample labels, in accordance with some embodiments.

FIG. 6 is a flowchart of a method of creating an occupancy region-based map, in accordance with some embodiments.

FIG. 7A is a schematic diagram of an occupancy region map, in accordance with some embodiments.

FIG. 7B is a Tabular representation of an example occupancy region map indicating available free regions corresponding to a grid in center-position, in accordance with some embodiments.

FIG. 8 is a process flow diagram of a process of generating sample labels, in accordance with some exemplary embodiments.

FIG. 9 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The present subject matter provides for generating high-fidelity sample label dataset based on the user demands to train the ML models and automatic annotating of the synthesized images. The high-fidelity training dataset is created using a variety of icons (e.g. medical label symbols) and background images, and automatically annotating the sample labels. An input from a user is received on various aspects like (i) number of images requires, (ii) icons/symbols that need to be presented, and (iii) type of background. Further, the user can customize augmentation techniques used on the sample labels to create variations of the sample labels. The augmentation technique incorporate variations in the images/icon by means of geometric distortions, addition of noise, lens distortions etc., and therefore enable the ML models to learn these distorted images and enable them to be robust in detecting those icons using testing phase.

A set of icons and background are selected, which are relevant to the product category. Some icons like manufacturer symbol are often associated with the text information describing the manufacturer address. To this end, a set of text and its associated icons are also chosen. Pre-Augmentation operations are performed for the selected icons/symbols and the augmented symbols/icons are randomly placed in selected backgrounds to synthesize the training dataset. The coordinates are saved for annotation. Further, post-augmentation operations are applied on the sample labels (images), to introduce distortions in the images. Finally, the images and their corresponding annotations are stored in a database. Each sample label may be created by randomly selecting the background and one or more icons. The icons are checked for their association with text. If there is a corresponding text, then a complete image segment is created by placing the icon and text in appropriate positions. Pre-augmentation operations are applied for the selected icon and placed in the background using an occupancy region map. The occupancy region map ensures that there is no overlap of icons and there is sufficient space between the icons, thereby making the synthetic images identical to the actual labels (which were designed manually). Once the icons are placed in appropriate position, then the symbols are annotated using their location in the image. The occupancy region map is also updated for the placed icon. This process continues until the maximum number of icons per image defined by the user are reached or there is no further space to place new icons. Post-augmentation operations are performed for the created image and the change in the icon location is captured to update the annotation. The algorithm terminates once the maximum number of images defined by the user are reached. Thus, the dataset for training the ML model is created with high quality synthesis images.

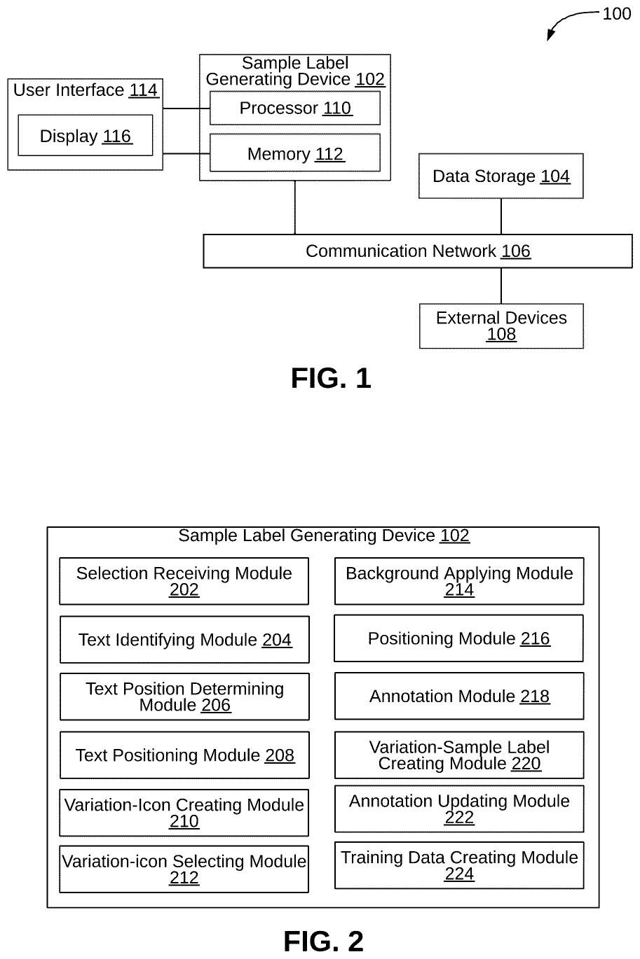

Referring now to FIG. 1, a block diagram of an exemplary system 100 for generating sample labels is illustrated, in accordance with some embodiments of the present disclosure. The system 100 may implement a sample label generating device 102. The sample label generating device 102 may be a computing device having data processing capability. Examples of the sample label generating device 102 may include, but are not limited to a desktop, a laptop, a notebook, a netbook, a tablet, a smartphone, a mobile phone, an application server, a web server, or the like. The system 100 may further include a data storage 104. Additionally, the sample label generating device 102 may be communicatively coupled to an external device 108 for sending and receiving various data. Examples of the external device 108 may include, but are not limited to, a remote server, digital devices, and a computer system. A computing device, a smartphone, a mobile device, a laptop, a smartwatch, a personal digital assistant (PDA), an e-reader, and a tablet are all examples of external devices 108.

The sample label generating device 102 may connect to the external device 108 over a communication network 106. The sample label generating device 102 may connect to external device 108 via a wired connection, for example via Universal Serial Bus (USB).

The sample label generating device 102 may be configured to perform one or more functionalities that may include receiving, from a user, a selection of: one or more icons from a plurality of icons and a selection of one or more backgrounds from a plurality of backgrounds. The one or more functionalities may further include creating a first plurality of variation-icons corresponding to each of the one or more icons, by applying one or more pre-augmentation operations to each of the one or more icons and selecting a set of variation-icons from a second plurality of variation-icons corresponding to the one or more icons, based on dimensions of each variation-icon of the set of variation-icons and predefined dimensions of a sample label template. The one or more functionalities may further include applying a background of the one or more backgrounds to the sample label template and positioning the set of variation-icons in the sample label template over the background of the one or more backgrounds, to generate a sample label.

To perform the above functionalities, the sample label generating device 102 may include a processor 110 and a memory 112. The memory 112 may be communicatively coupled to the processor 110. the memory 112 may store a plurality of instructions, which upon execution by the processor 110, cause the processor to perform the above functionalities. The sample label generating device 102 may further implement a user interface 114 that may further implement a display 116. Examples may include, but are not limited to a display, keypad, microphone, audio speakers, vibrating motor, LED lights, etc. The user interface 114 may receive input from a user and also display an output of the computation performed by the sample label generating device 102.

Referring now to FIG. 2, a block diagram of the sample label generating device 102 showing one or more modules is illustrated, in accordance with some embodiments. In some embodiments, the sample label generating device 102 may include a selection receiving module 202, a text identifying module 204, a text position determining module 206, a text positioning module 208, a variation-icon creating module 210 (pre-augmentation module), a variation-icon selecting module 212, a background applying module 214, a positioning module 216, a annotation module 218, a variation-sample label creating module 220 (post-augmentation module), an annotation updating module 222, and a training data creating module 224.

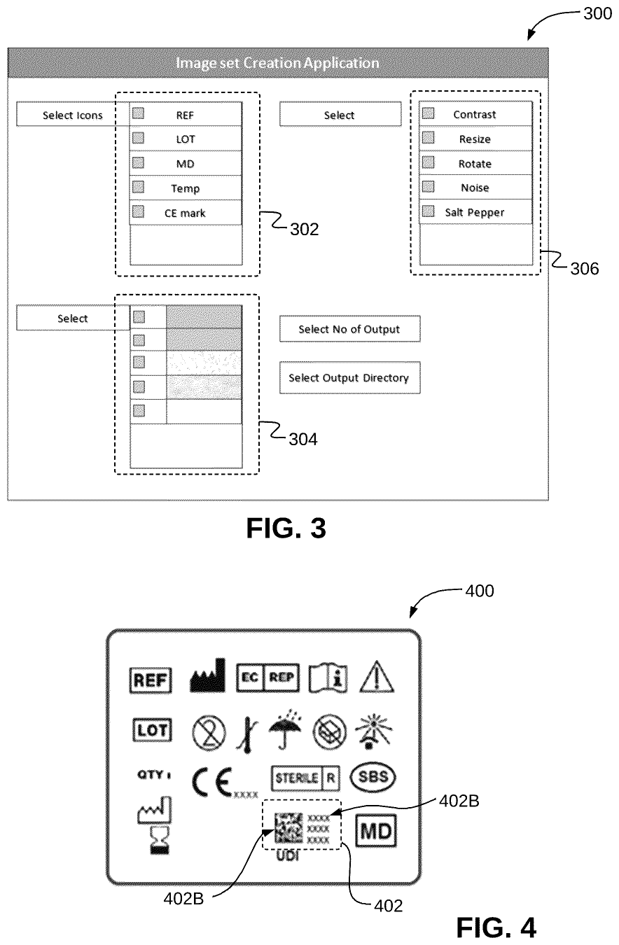

The selection receiving module 202 may receive a selection from a from a user. The selection may include selection of one or more icons from a plurality of icons, and a selection of one or more backgrounds from a plurality of backgrounds. It should be noted that the above section may be received via a user interface. FIG. 3 shows a snapshot of an exemplary user interface 300 for receiving the selection of one or more icons from the plurality of icons, and the selection of one or more backgrounds from the plurality of backgrounds. As shown in FIG. 3, the user interface 300 may include a plurality of icon-buttons 302 corresponding to the plurality of icons pre-stored in a database. Further, the user interface 300 may include a plurality of background-buttons 304 corresponding to the plurality of backgrounds pre-stored in the database. For example, the plurality of icon-buttons 302 and the plurality of background-buttons 304 may be radio buttons. As such, a user may click on one or more icon-buttons 302 to select the one or more icons and click on one or more background-buttons 304 to select the one or more backgrounds. Further, the user interface 300 may include pre-augmentation operation buttons 306 to perform pre-augmentation operations such as geometric distortion (e.g. resizing, rotating, etc.), noise addition, lens distortion, contrast adjusting, salt and pepper effect addition, etc.

Referring again to FIG. 2, as will be appreciated by those skilled in the art, some symbols may include an icon along with an associated text. To this end, the text identifying module 204 may identify a text associated with each of one or more icons. Further, the text position determining module 206 may determine a position of the text associated with each icon of one or more icons with respect to the respective icon of the one or more icons. The text positioning module 208 may position the text associated with each icon of one or more icons at the associated position with respect to the respective icon of the one or more icons. Therefore, a symbol may be generated once the text associated with the icon is positioned at the at the associated position with respect to the respective icon. This can be better understood from a sample label 400 as illustrated in FIG. 4. As shown in FIG. 4, the sample label 400 may include one or more icons and symbols. For example, a symbol 402 may include an associated icon 402A and an associated text 402B. Icons, for example an icon 404, may exist individually without any associated text.

The variation-icon creating module 210 (also, referred to as pre-augmentation module) may create a first plurality of variation-icons corresponding to each of the one or more icons, by applying one or more pre-augmentation operations to each of the one or more icons. The user may select the pre-augmentation operations using the pre-augmentation buttons 306 from the user-interface 302, as described above. In some embodiments, the one or more pre-augmentation operations may include at least one geometric distortion, a noise addition, and at least one lens distortion. For example, the geometric distortion may include changing orientation angle of the image in a 2-dimensional space, flipping the icon about a horizontal axis or vertical axis, etc. The noise addition may include introducing graininess, changing contrast, etc. As such, on each of the one or more icons, different geometric distortions, noise additions, and lens distortions may be applied to generate the first plurality of variation-icons. Therefore, a second plurality of variation-icons may be created corresponding to the one or more icons (i.e. the second plurality of variation-icons is the combination of the variation-icons for all of the one or more icons).

The variation-icon selecting module 212 may be configured to select a set of variation-icons from the second plurality of variation-icons corresponding to the one or more icons. The set of variation-icons may be selected based on dimensions of each variation-icon of the set of variation-icons and predefined dimensions of a sample label template. The background applying module 214 may apply a background of the one or more backgrounds to the sample label template.

The positioning module 216 may position the set of variation-icons in the sample label template over the background of the one or more backgrounds, to generate a sample label. In some embodiments, positioning the set of variation-icons in the sample label template may include determining an optimized position of each icon of the set of icons in the sample label template, based on an occupancy region map. In order to determine the optimized position of each icon of the set of icons in the sample label template, the positioning module 216 may randomly position an icon of the set of icons at a first location in the sample label template. For example, each icon of the set of icons and the sample label template may be configured in a rectangular shape. The positioning module 216 may further position remaining icons of the set of icons in a vacant region within the sample label template. It should be noted that the set of icons may be equally spaced from each other. Further, the set of icons may be spaced by a predetermined gap.

Once the set of variation-icons are positioned in the sample label template over the background of the one or more backgrounds, the annotation module 218 may annotate each of the set of variation-icons based on a location associated with the respective variation-icons of the set of variation-icons.

The variation-sample label creating module 220 (also referred to as post-augmentation module) may create a third plurality of variation-sample labels corresponding to each of a fourth plurality of sample labels, by applying one or more post-augmentation operations to each of the fourth plurality of sample labels. It should be noted that the fourth plurality of sample labels may be generated using a plurality of unique combinations of sets of variation-icons from the second plurality of variation-icons corresponding to the one or more icons and the one or more backgrounds. By way of example, the one or more post-augmentation operations may include a rotation, a vertical flipping, and a horizontal flipping of each of the fourth plurality of sample labels.

Once the one or more post-augmentation operations are applied to each of the fourth plurality of sample labels, the annotation updating module 222 may update annotation of each of the set of variation-icons based on an updated location associated with the respective variation-icons of the set of variation-icons. The training data creating module 224 may create a training data set for training a machine leaning (ML) model for identifying labels, the training data set comprising the third plurality of variation-sample labels.

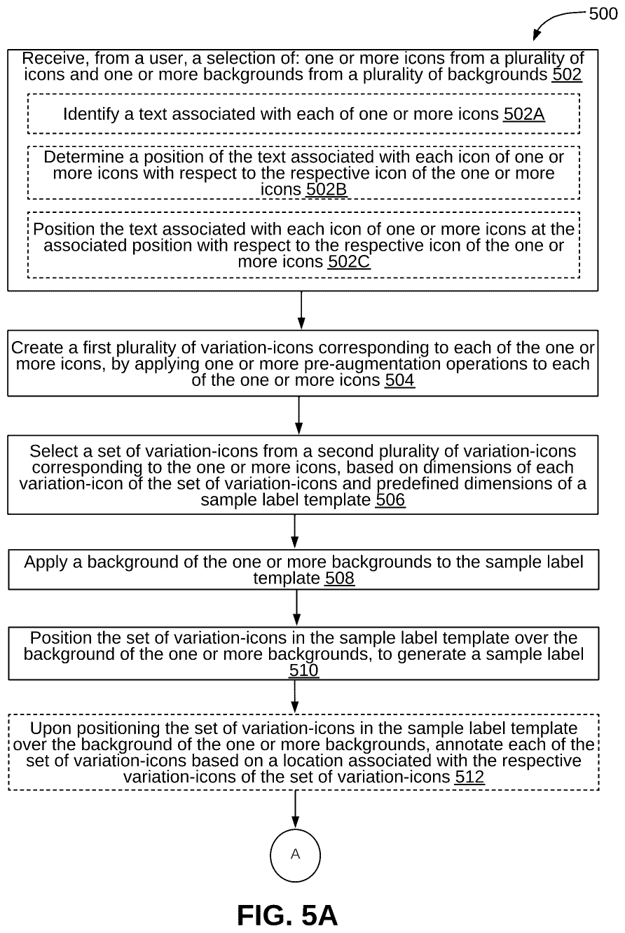

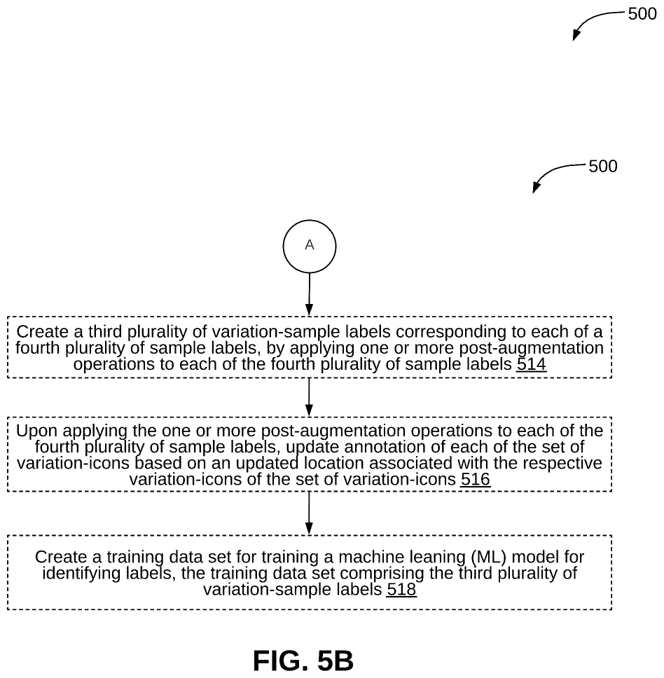

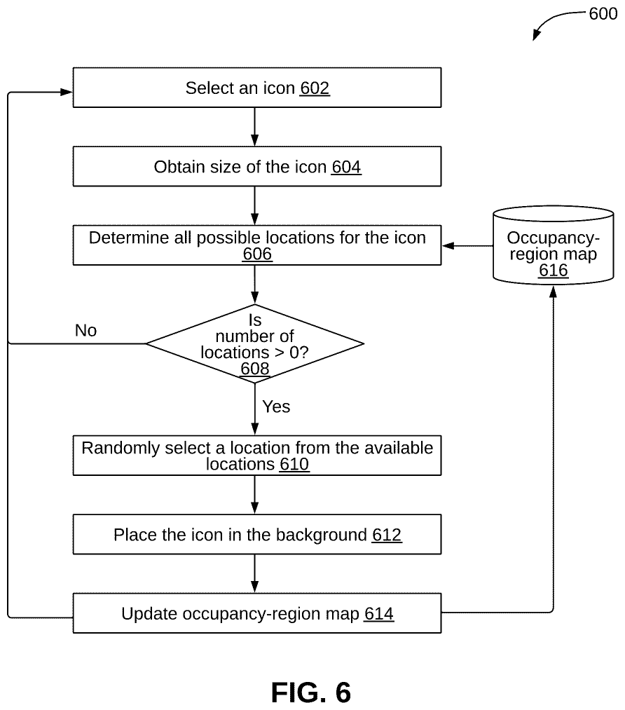

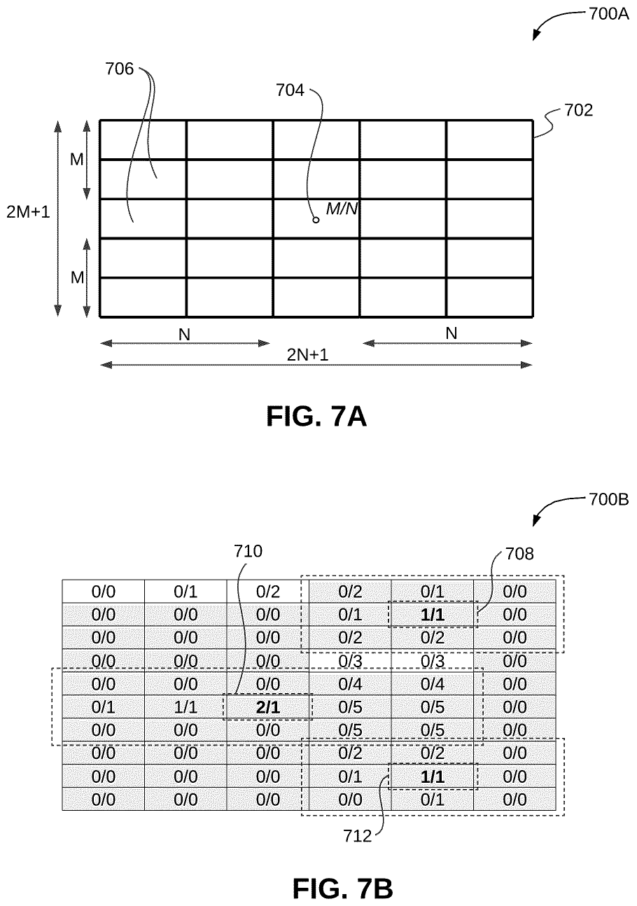

Referring now to FIGS. 5A-5B, a flowchart of a method 500 of generating sample labels is illustrated, in accordance with some embodiments. The method 500 may be performed by the sample label generating device 102. The method 500 is explained in conjunction with FIGS. 6-7.

At step 502, a selection may be received from a user of one or more icons from a plurality of icons and one or more backgrounds from a plurality of backgrounds. For example, icons and background which are relevant to a product category in considerations may be selected. Further, in some example scenarios, the one or more icons and backgrounds may be randomly selected.

In some scenarios, a text may be associated with the icons. As will be appreciated, some icons like manufacturer symbol are often associated with the text information describing the manufacturer address. Hence, a set of text and its associated icons may also be selected. To this end, in some embodiments, additionally, at step 502A, a text associated with each of one or more icons may be identified. At step 502B, a position of the text associated with each icon of one or more icons with respect to the respective icon of the one or more icons may be determined. At step 502C, the text associated with each icon of one or more icons may be positioned at the associated position with respect to the respective icon of the one or more icons. In some embodiments, additionally, at step 502, an input from a user may be received on number of sample labels required, i.e., size of the data set required, for example, for training a machine learning (ML) model.

At step 504, a first plurality of variation-icons may be created corresponding to each of the one or more icons, by applying one or more pre-augmentation operations to each of the one or more icons. For example, the one or more pre-augmentation operations may include at least one geometric distortion, a noise addition, and at least one lens distortion. The pre-augmentation operations may incorporate variations in the icons by way of introducing geometric distortions, addition of noise, lens distortions etc., that may enable the ML model to learn various distorted images and further enable the ML model to be robust in detecting these icons. It should be noted that the user may customize the pre-augmentation operations, i.e., the users may select the pre-augmentation operations that they want to be performed. The pre-augmentation operations are employed for the selected icons/symbols. Thereafter, augmented symbols/icons may be randomly placed in the selected backgrounds, to synthesis the sample labels. Further, coordinates of these sample labels may be saved for annotation.

At step 506, a set of variation-icons may be selected from a second plurality of variation-icons corresponding to the one or more icons, based on dimensions of each variation-icon of the set of variation-icons and predefined dimensions of a sample label template. As mentioned above, the second plurality of variation-icons may be created corresponding to the one or more icons (i.e. the second plurality of variation-icons is the combination of the variation-icons for all of the one or more icons). At step 508, a background of the one or more backgrounds may be applied to the sample label template. At step 510, the set of variation-icons ay be positioned in the sample label template over the background of the one or more backgrounds, to generate a sample label.

In some embodiments, positioning the set of variation-icons in the sample label template may include determining an optimized position of each icon of the set of icons in the sample label template, based on an occupancy region map. Further, it should be noted that the in order to determine the optimized position of each icon of the set of icons in the sample label template, first an icon of the set of icons may be randomly positioned at a first location in the sample label template. For example, each icon of the set of icons and the sample label template may be configured in a rectangular shape. Thereafter, the remaining icons of the set of icons may be positioned in a vacant region within the sample label template. In some embodiments, the set of icons may be equally spaced from each other. Further, the set of icons may be spaced by a predetermined gap.

The occupancy region map ensures no overlap of icons and sufficient space between them making the sample labels identical to the actual labels, which were designed manually. The occupancy region map may be updated for the positioned icon and this process may continue until maximum number of icons per sample label defined by the user are reached or there is no further space to place new icons in the sample label. The occupancy region map is explained in detail in conjunction with FIG. 6.

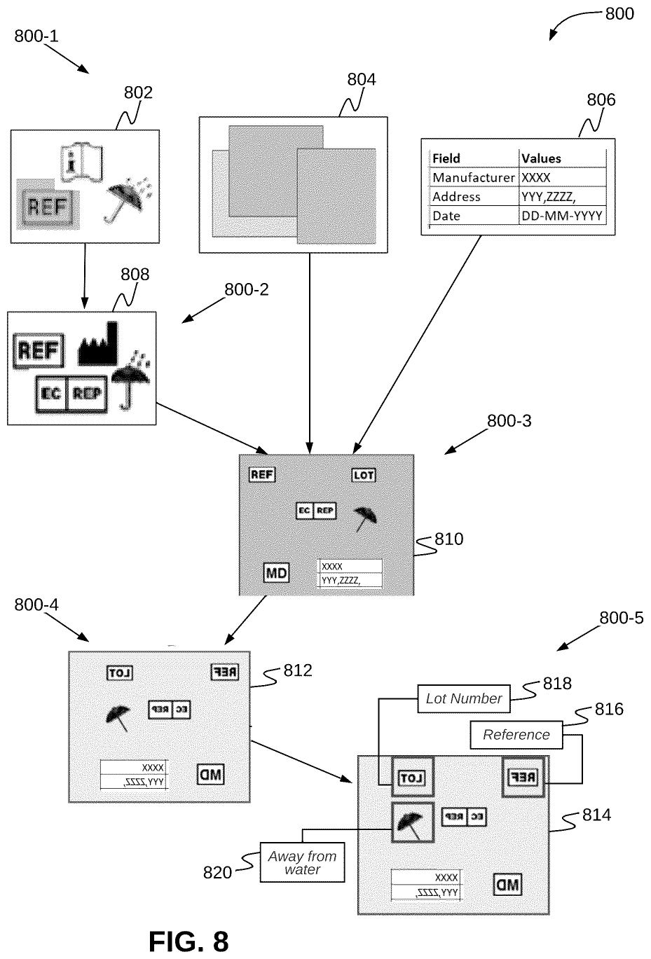

Referring now to FIG. 6, a flowchart of a method 600 of creating an occupancy region map is illustrated, in accordance with some embodiments. At step 602, a selection of one or more icons (or symbols) may be received, as explained via step 502 of FIGS. 5A-5B. At step 604, a size of each of the one or more icons may be obtained. Once the size of the icons is obtained, all possible locations for each of the icons in an occupancy region map 616 (associated with the sample label template) may be determined. The occupancy region map 616 is further explained in detail in conjunction with FIGS. 7-8.

Referring now to FIG. 7A, a schematic diagram of an occupancy region map 700A (corresponding to the occupancy region map 616) is illustrated, in accordance with some embodiments. It should be noted that the occupancy region map 700A may define each sample label template as an equally spaced occupancy grid, in a free (rectangular) region 702. Each grid 706 may have a predefined length (M) and a predefined breath (N) of free region that can be formed using that grid as center position 704. Hence, the total dimensions of the free region 702 will be of dimensions (2M+1)×(2N+1). The occupancy region map 700A may enable positioning of the icons of the corresponding size in the available free region 702. The free region may be configured to form rectangular region to accommodate rectangular-shaped icons. Further, the free region may be annotated using rectangular bounding box. The occupancy region map 700A may further ensure proper selection of icons that can accommodate the free region without any overlapping.

By way of an example, the size of a selected icon (m×n) may be determined, and a matched free region may be extracted from the occupancy region map. The length (M) and breadth (N) indicated in the grid should be higher than the length (m) and breath (n) of the icon, respectively, i.e. M≥m, and breadth N≥n. If no possible location (grid) is found for an icon, then the icon may be discarded and a new icon may be selected. Otherwise, a location may be randomly selected for the icon, and the icon may be positioned at that location. This ensures no overlapping and maximum usage of the available space in the label. The occupancy region map 700A may be updated to reflect the placement of the new icon. An example occupancy region map 700B indicating the available free regions corresponding to a grid in the center-position is illustrated in FIG. 7B. As shown in FIG. 7B, three free regions are available corresponding to center-position grids 708, 710, 712.

Referring again to FIG. 6, at step 608, a check may be performed to determine whether the number of locations (as determined at step 606) is more than zero. If the number of locations is determined to be not more than zero, then the method 600 may once again proceed to step 602 (“No” path) and the subsequent steps may be repeated. However, at step 608, if the number of locations is determined to be more than zero, then the method 600 may proceed to step 610 (“Yes” path). At step 610, one available location may be selected randomly. At step 612, the icon may be positioned on the occupancy region map 616 at the location as selected at step 610. At step 614, the occupancy region map 616 may be updated, in response to positioning of the icon on the occupancy region map 616 at the selected location.

Referring once again to FIGS. 5A-5B, in some embodiments, additionally, at step 512, upon positioning the set of variation-icons in the sample label template over the background of the one or more backgrounds, each of the set of variation-icons may be annotated based on a location associated with the respective variation-icons of the set of variation-icons. In other words, once the icons are placed in appropriate position, then the symbols may be annotated using their location in the sample label.

At step 514, a third plurality of variation-sample labels corresponding to each of a fourth plurality of sample labels may be created, by applying one or more post-augmentation operations to each of the fourth plurality of sample labels. It should be noted that the fourth plurality of sample labels may be generated using various unique combinations of sets of variation-icons from the second plurality of variation-icons corresponding to the one or more icons and the one or more backgrounds. In other words, the fourth plurality of sample labels (created using various unique combinations of the sets of variation-icons and the one or more backgrounds) may be subjected to the one or more post-augmentation operations to create the third plurality of variation-sample labels corresponding to the fourth plurality of sample labels. By way of an example, the one or more post-augmentation operations may include a rotation, a vertical flipping, and a horizontal flipping of each of the fourth plurality of sample labels. As will be understood, the post-augmentation operations may be applied for the sample labels, which allow introducing distortions to the sample labels. These sample labels and its corresponding annotations are stored in the database. The post-augmentation operations may be applied for the created sample label and the change in icon location may be captured to update the annotation. Once the maximum number of images defined by the user is reached, the process may be stopped. As a result, the dataset for training the ML model is created with high quality synthesis sample labels.

At step 516, upon applying the one or more post-augmentation operations to each of the fourth plurality of sample labels, annotation of each of the set of variation-icons may be updated based on an updated location associated with the respective variation-icons of the set of variation-icons. At step 518, a training data set may be crated for training a machine leaning (ML) model for identifying labels. The training data set may include the third plurality of variation-sample labels.

Referring now to FIG. 8, a process flow diagram of a process 800 of generating sample labels is illustrated, in accordance with some exemplary embodiments. At step 800-1, a selection is received from a user of one or more icons 802 from a plurality of icons. Further, at step 800-1, a selection is received of one or more backgrounds 804 from a plurality of backgrounds. In some scenarios, a text may be associated with the icons. Therefore, in some embodiments, additionally, at step 800-1, a text 806 associated with each of one or more icons 801 may be identified. Further, a position of the text 806 associated with each icon of one or more icons 802 with respect to the respective icon of the one or more icons 802 may be determined and the text associated with each icon may be positioned at the associated position with respect to the respective icon.

At step 800-2, one or more pre-augmentation operations may be applied to each of the one or more icons 802 to create variation-icons 808 corresponding to each of the one or more icons 802. The one or more pre-augmentation operations, for example, may include at least one geometric distortion, a noise addition, and at least one lens distortion. In some embodiments, once the one or more pre-augmentation operations are applied, a set of variation-icons may be selected from the variation-icons 808, based on dimensions of each variation-icon of the set of variation-icons and predefined dimensions of a sample label template. At step 800-3, a background of the one or more backgrounds 804 may be applied to the sample label template and the set of variation-icons may be positioned in the sample label template over the background, to generate a sample label 810. Furthermore, upon positioning the set of variation-icons in the sample label template over the background of the one or more backgrounds, each of the set of variation-icons may be annotated based on a location associated with the respective variation-icons of the set of variation-icons.

At step 800-4, one or more post-augmentation operations may be applied to the sample label 810 to create variation-sample label(s) 812 corresponding to the sample label 810. For example, the one or more post-augmentation operations may include a rotation, a vertical flipping, and a horizontal flipping of each of the fourth plurality of sample labels. It should be noted that the sample label(s) 810 may be generated using a plurality of unique combinations of sets of variation-icons from the second plurality of variation-icons corresponding to the one or more icons and the one or more backgrounds.

At step 800-5, upon applying the one or more post-augmentation operations to each of the fourth plurality of sample labels, annotation of each of the set of variation-icons may be updated, as depicted by 814, based on an updated location associated with the respective variation-icons of the set of variation-icons. As shown in FIG. 8, annotations 816, 818, 820 may be added to the set of variation-icons. For example, the annotations 816, 818, 820 may be indicative of “Lot Number”, “Reference”, and “Away from water” corresponding to the respective variation-icons.

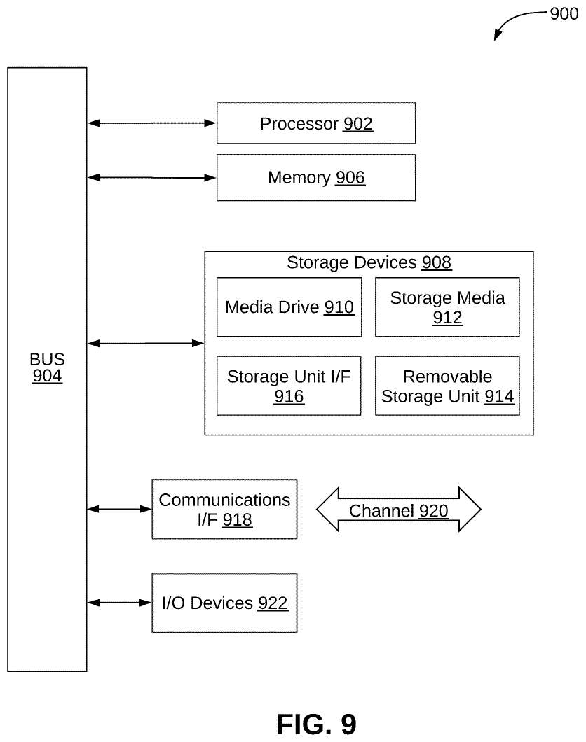

Referring now to FIG. 9, an exemplary computing system 900 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 900 may represent, for example, a user device such as a desktop, a laptop, a mobile phone, personal entertainment device, DVR, and so on, or any other type of special or general-purpose computing device as may be desirable or appropriate for a given application or environment. The computing system 900 may include one or more processors, such as a processor 902 that may be implemented using a general or special purpose processing engine such as, for example, a microprocessor, microcontroller or other control logic. In this example, the processor 902 is connected to a bus 904 or other communication media. In some embodiments, the processor 902 may be an Artificial Intelligence (AI) processor, which may be implemented as a Tensor Processing Unit (TPU), or a graphical processor unit, or a custom programmable solution Field-Programmable Gate Array (FPGA).

The computing system 900 may also include a memory 906 (main memory), for example, Random Access Memory (RAM) or other dynamic memory, for storing information and instructions to be executed by the processor 902. The memory 906 also may be used for storing temporary variables or other intermediate information during the execution of instructions to be executed by processor 902. The computing system 900 may likewise include a read-only memory (“ROM”) or other static storage device coupled to bus 904 for storing static information and instructions for the processor 902.

The computing system 900 may also include storage devices 908, which may include, for example, a media drive 910 and a removable storage interface. The media drive 910 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 912 may include, for example, a hard disk, magnetic tape, flash drive, or other fixed or removable media that is read by and written to by the media drive 910. As these examples illustrate, the storage media 912 may include a computer-readable storage medium having stored therein particular computer software or data.

In alternative embodiments, the storage devices 908 may include other similar instrumentalities for allowing computer programs or other instructions or data to be loaded into the computing system 900. Such instrumentalities may include, for example, a removable storage unit 914 and a storage unit interface 916, such as a program cartridge and cartridge interface, a removable memory (for example, a flash memory or other removable memory module) and memory slot, and other removable storage units and interfaces that allow software and data to be transferred from the removable storage unit 914 to the computing system 900.

The computing system 900 may also include a communications interface 918. The communications interface 918 may be used to allow software and data to be transferred between the computing system 900 and external devices. Examples of the communications interface 918 may include a network interface (such as an Ethernet or other NIC card), a communications port (such as for example, a USB port, a micro-USB port), Near field Communication (NFC), etc. Software and data transferred via the communications interface 918 are in the form of signals which may be electronic, electromagnetic, optical, or other signals capable of being received by the communications interface 918. These signals are provided to the communications interface 918 via a channel 920. The channel 920 may carry signals and may be implemented using a wireless medium, wire or cable, fiber optics, or other communications medium. Some examples of the channel 920 may include a phone line, a cellular phone link, an RF link, a Bluetooth link, a network interface, a local or wide area network, and other communications channels.

The computing system 900 may further include Input/Output (I/O) devices 922. Examples may include, but are not limited to a display, keypad, microphone, audio speakers, vibrating motor, LED lights, etc. The I/O devices 922 may receive input from a user and also display an output of the computation performed by the processor 902. In this document, the terms “computer program product” and “computer-readable medium” may be used generally to refer to media such as, for example, the memory 906, the storage devices 908, the removable storage unit 914, or signal(s) on the channel 920. These and other forms of computer-readable media may be involved in providing one or more sequences of one or more instructions to the processor 902 for execution. Such instructions, generally referred to as “computer program code” (which may be grouped in the form of computer programs or other groupings), when executed, enable the computing system 900 to perform features or functions of embodiments of the present invention.

In an embodiment where the elements are implemented using software, the software may be stored in a computer-readable medium and loaded into the computing system 900 using, for example, the removable storage unit 914, the media drive 910 or the communications interface 918. The control logic (in this example, software instructions or computer program code), when executed by the processor 902, causes the processor 902 to perform the functions of the invention as described herein.

One or more techniques for generating sample labels are disclosed above. The above techniques do away with the requirement of manual acquisition of images (i.e. sample labels) from various sources like camera, video frames etc., by instead synthesizing the images from the available icons/symbols and text. Further, the above techniques do away with the manual annotation, as the techniques provide for creating the sample labels using optimal placement of icons within occupancy region map, thereby enabling automatic annotating of the icons. Furthermore, the techniques provide flexibility of customizing the creation of sample labels, thereby overcoming problems of unbalanced dataset. As such, the techniques provide for automated procedure of generating dataset of sample labels, with significantly reduced time and manual effort involved in image acquisition and annotation. Further, there is no limitation on the volume of dataset to be generated. Furthermore, the techniques provide flexibility of customizing the complexity and features of the generated dataset. Moreover, the use of occupancy region map ensures the quality of the sample labels closer to the actual labels used in the products.

It is intended that the disclosure and examples be considered as exemplary only, with a true scope and spirit of disclosed embodiments being indicated by the following claims.

We claim:

1. A method of generating sample labels, the method comprising:
receiving, by a sample label generating device, from a user, a selection of:
one or more icons from a plurality of icons; and
one or more backgrounds from a plurality of backgrounds;
creating, by the sample label generating device, a first plurality of variation-icons corresponding to each of the one or more icons, by applying one or more pre-augmentation operations to each of the one or more icons;
selecting, by the sample label generating device, a set of variation-icons from a second plurality of variation-icons corresponding to the one or more icons, based on dimensions of each variation-icon of the set of variation-icons and predefined dimensions of a sample label template;
applying, by the sample label generating device, a background of the one or more backgrounds to the sample label template; and
positioning, by the sample label generating device, the set of variation-icons in the sample label template over the background of the one or more backgrounds, to generate a sample label.

2. The method of claim 1 further comprising:
identifying a text associated with each of one or more icons;
determining a position of the text associated with each icon of one or more icons with respect to the respective icon of the one or more icons; and
positioning the text associated with each icon of one or more icons at the associated position with respect to the respective icon of the one or more icons.

3. The method of claim 1 further comprising:
upon positioning the set of variation-icons in the sample label template over the background of the one or more backgrounds, annotating each of the set of variation-icons based on a location associated with the respective variation-icons of the set of variation-icons.

4. The method of claim 3 further comprising:
creating a third plurality of variation-sample labels corresponding to each of a fourth plurality of sample labels, by applying one or more post-augmentation operations to each of the fourth plurality of sample labels,
wherein the fourth plurality of sample labels is generated using a plurality of unique combinations of sets of variation-icons from the second plurality of variation-icons corresponding to the one or more icons and the one or more backgrounds, and
wherein the one or more post-augmentation operations comprise: a rotation, a vertical flipping, and a horizontal flipping of each of the fourth plurality of sample labels.

5. The method of claim 4 further comprising:
upon applying the one or more post-augmentation operations to each of the fourth plurality of sample labels, updating annotation of each of the set of variation-icons based on an updated location associated with the respective variation-icons of the set of variation-icons.

6. The method of claim 1, wherein positioning the set of variation-icons in the sample label template comprises:
determining an optimized position of each icon of the set of icons in the sample label template, based on an occupancy region-based map.

7. The method of claim 6, wherein determining the optimized position of each icon of the set of icons in the sample label template comprises:
randomly positioning an icon of the set of icons at a first location in the sample label template, wherein each icon of the set of icons and the sample label template is configured in a rectangular shape; and
positioning remaining icons of the set of icons in a vacant region within the sample label template,
wherein the set of icons are equally spaced from each other, and
wherein the set of icons are spaced by a predetermined gap.

8. The method of claim 1 further comprising:
creating a training data set for training a machine leaning (ML) model for identifying labels, the training data set comprising the third plurality of variation-sample labels.

9. The method of claim 1, wherein the one or more pre-augmentation operations comprise: at least one geometric distortion, a noise addition, and at least one lens distortion.

10. A system for generating sample labels, the system comprising:
a processor; and
a memory communicatively coupled to the processor, wherein the memory stores a plurality of processor-executable instructions, which upon execution by the processor, cause the processor to:
receive, from a user, a selection of:
one or more icons from a plurality of icons; and
one or more backgrounds from a plurality of backgrounds;
create a first plurality of variation-icons corresponding to each of the one or more icons, by applying one or more pre-augmentation operations to each of the one or more icons;
select a set of variation-icons from a second plurality of variation-icons corresponding to the one or more icons, based on dimensions of each variation-icon of the set of variation-icons and predefined dimensions of a sample label template;
apply a background of the one or more backgrounds to the sample label template; and
position the set of variation-icons in the sample label template over the background of the one or more backgrounds, to generate a sample label.

11. The system of claim 10, wherein the processor-executable instructions further cause the processor to:
identify a text associated with each of one or more icons;
determine a position of the text associated with each icon of one or more icons with respect to the respective icon of the one or more icons; and
position the text associated with each icon of one or more icons at the associated position with respect to the respective icon of the one or more icons.

12. The system of claim 10, wherein the processor-executable instructions further cause the processor to:
upon positioning the set of variation-icons in the sample label template over the background of the one or more backgrounds, annotate each of the set of variation-icons based on a location associated with the respective variation-icons of the set of variation-icons;
create a third plurality of variation-sample labels corresponding to each of a fourth plurality of sample labels, by applying one or more post-augmentation operations to each of the fourth plurality of sample labels,
wherein the fourth plurality of sample labels is generated using a plurality of unique combinations of sets of variation-icons from the second plurality of variation-icons corresponding to the one or more icons and the one or more backgrounds, and
wherein the one or more post-augmentation operations comprise: a rotation, a vertical flipping, and a horizontal flipping of each of the fourth plurality of sample labels.

13. The system of claim 10, wherein positioning the set of variation-icons in the sample label template comprises:
determining an optimized position of each icon of the set of icons in the sample label template, based on an occupancy region-based map, and wherein determining the optimized position of each icon of the set of icons in the sample label template comprises:
randomly positioning an icon of the set of icons at a first location in the sample label template, wherein each icon of the set of icons and the sample label template is configured in a rectangular shape; and
positioning remaining icons of the set of icons in a vacant region within the sample label template,
wherein the set of icons are equally spaced from each other, and
wherein the set of icons are spaced by a predetermined gap.

14. The system of claim 10, wherein the processor-executable instructions further cause the processor to:
create a training data set for training a machine leaning (ML) model for identifying labels, the training data set comprising the third plurality of variation-sample labels.

15. A non-transitory computer-readable medium storing computer-executable instructions for generating sample labels, the computer-executable instructions configured for:
receiving, from a user, a selection of:
one or more icons from a plurality of icons; and
one or more backgrounds from a plurality of backgrounds;
creating a first plurality of variation-icons corresponding to each of the one or more icons, by applying one or more pre-augmentation operations to each of the one or more icons;
selecting a set of variation-icons from a second plurality of variation-icons corresponding to the one or more icons, based on dimensions of each variation-icon of the set of variation-icons and predefined dimensions of a sample label template;
applying a background of the one or more backgrounds to the sample label template; and
positioning the set of variation-icons in the sample label template over the background of the one or more backgrounds, to generate a sample label.

16. The non-transitory computer-readable medium of claim 15, wherein the computer-executable instructions are further configured for:
identifying a text associated with each of one or more icons;
determining a position of the text associated with each icon of one or more icons with respect to the respective icon of the one or more icons; and
positioning the text associated with each icon of one or more icons at the associated position with respect to the respective icon of the one or more icons.

17. The non-transitory computer-readable medium of claim 15, wherein the computer-executable instructions are further configured for:
upon positioning the set of variation-icons in the sample label template over the background of the one or more backgrounds, annotating each of the set of variation-icons based on a location associated with the respective variation-icons of the set of variation-icons.

18. The non-transitory computer-readable medium of claim 15, wherein the computer-executable instructions are further configured for:
creating a third plurality of variation-sample labels corresponding to each of a fourth plurality of sample labels, by applying one or more post-augmentation operations to each of the fourth plurality of sample labels,
wherein the fourth plurality of sample labels is generated using a plurality of unique combinations of sets of variation-icons from the second plurality of variation-icons corresponding to the one or more icons and the one or more backgrounds, and
wherein the one or more post-augmentation operations comprise: a rotation, a vertical flipping, and a horizontal flipping of each of the fourth plurality of sample labels.

19. The non-transitory computer-readable medium of claim 18, wherein the computer-executable instructions are further configured for:
upon applying the one or more post-augmentation operations to each of the fourth plurality of sample labels, updating annotation of each of the set of variation-icons based on an updated location associated with the respective variation-icons of the set of variation-icons.

20. The non-transitory computer-readable medium of claim 15, wherein positioning the set of variation-icons in the sample label template comprises:
determining an optimized position of each icon of the set of icons in the sample label template, based on an occupancy region-based map, and wherein determining the optimized position of each icon of the set of icons in the sample label template comprises:
randomly positioning an icon of the set of icons at a first location in the sample label template, wherein each icon of the set of icons and the sample label template is configured in a rectangular shape; and
positioning remaining icons of the set of icons in a vacant region within the sample label template,
wherein the set of icons are equally spaced from each other, and
wherein the set of icons are spaced by a predetermined gap.
